(19) United States
(12) Patent Application Publication
(10) Pub. No.: US 2026/0022833 A1
(43) Pub. Date: Jan. 22, 2026

(54) FLASHLIGHT WITH ADJUSTABLE FORM FACTOR

(71) Applicant: 5.11, Inc., Costa Mesa, CA (US)

(72) Inventors: Matthew David Noble, Long Beach, CA (US); Terry Serpa, South Pasadena, CA (US); Sharon Park, Irvine, CA (US)

(21) Appl. No.: 19/272,796

(22) Filed: Jul. 17, 2025

Related U.S. Application Data
(60) Provisional application No. 63/672,591, filed on Jul. 17, 2024.

(51) Int. Cl. F21V 33/00; F21L 4/08; F21V 17/12; F21V 17/16; F21V 23/04; F21V 23/06

(52) U.S. Cl. CPC F21V 33/0084; F21L 4/085; F21V 17/12; F21V 17/164; F21V 23/0421; F21V 23/06

(57) ABSTRACT

A flashlight can include a body defining a head portion, a tail portion, and a middle portion extending between the head portion and the tail portion. A light source may be located in the head portion. A tail switch may be located in the tail portion and operable to change a setting of or otherwise control the light source. A customizable tail assembly may include a plurality of segments individually releasably attached to the tail portion.

### CROSS-REFERENCE TO RELATED PATENT APPLICATIONS

This application claims the benefit of and priority to U.S. Provisional Application No. 63/672,591, filed Jul. 17, 2024, which is hereby incorporated by reference in their entirety for all purposes.

### BACKGROUND OF THE DISCLOSURE

Flashlights may be utilized in a variety of circumstances. Typically flashlights have a self-contained power source and a light that can be powered by the power source. The self-contained nature of the power source can allow a flashlight to be utilized in many different situations where light may be useful without being plugged in or tethered to a wall socket or other utility grid interface. Flashlights may have different form factors that may be suitable for different uses or situations. However, a flashlight with a form-factor produced according to tailoring to one circumstance may render the flashlight less well-suited to use in another circumstance.

### BRIEF SUMMARY OF THE DISCLOSURE

The following presents a simplified summary of some embodiments of the present disclosure in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In various embodiments, provided may be a flashlight. The flashlight may include a body defining a head portion, a tail portion, and a middle portion extending between the head portion and the tail portion. The flashlight may include a light source located in the head portion. The flashlight may include a tail switch located in the tail portion and operable to change a setting of or otherwise control the light source. The flashlight may include a customizable tail assembly that may include one or more segments individually releasably attached to the tail portion and individually releasable independent of the tail switch.

In some embodiments, the tail switch and the segments each protrude away from an end-facing surface of the tail portion. At least one of the segments may extend further than the tail switch from the end-facing surface. The segments may be sized to provide an offset to prevent accidental triggering of the tail switch. Each segment may include a base having a bottom bearing an attachment interface configured for engaging the tail portion. Each segment may include an extension extending away from a top of the base. The extension may be shaped as a wall along an upper area that is penetrated by a through-hole. The attachment interface may include a lug and a peg each extending from the bottom of the base and each having a different maximum cross-sectional dimension. At least one of the segments may be formed as a secondary tool that includes at least one of a tether attachment tool, a window break tool, or a prying tool. The body of the flashlight further may include a plurality of grooves arranged to receive the clip at different positions along the body so as to adjust an amount of the flashlight that extends above the clip. The grooves may be arranged to receive the clip from differing sides of the flashlight so as to adjust along which side the clip is positioned.

In various embodiments, provided may be a tail assembly for a flashlight tail portion. The assembly may include a base having a top and a bottom. The assembly may include an attachment interface included in or coupled along the bottom of the base and operable to releasably attach the bottom of the base along an end-facing surface of a flashlight independently from a tail switch extending from the end-facing surface.

In some embodiments, the assembly may include an extension extending from the top of the base and forming a wall arranged to block a lateral path toward the tail switch in an installed position. The extension may include a terminus defining an offset surface configured to be positioned in the installed position a larger distance from the end-facing surface than a distance the tail switch extends from the end-facing surface. The attachment interface may include a lug and a peg each extending from the bottom of the base and each having a different maximum cross-sectional dimension. The peg may be penetrated by a threaded through-hole.

In various embodiments, provided may be a method of reconfiguring a flashlight form factor. The method may include accessing a flashlight having a tail portion with a tail switch and at least one tail segment individually releasably attached to the tail portion independently of the tail switch. The reconfiguring may include detaching at least one tail segment so as to convert the flashlight into a different configuration.

In some embodiments, the flashlight may be converted into a left-hand draw configuration by removing a leftward tail segment from the at least one tail segment. The flashlight may be converted into a right-hand draw configuration by removing a rightward tail segment from the at least one tail segment. The flashlight may be converted into a tail-segment-free configuration by removing a leftward tail segment and a rightward tail segment from the at least one tail segment.

For a fuller understanding of the nature and advantages of the present invention, reference should be made to the ensuing detailed description and accompanying drawings.

### BRIEF DESCRIPTION OF THE DRAWINGS

Various embodiments in accordance with the present disclosure will be described with reference to the drawings, in which:

FIG. 1 illustrates front and rear views of a flashlight with an adjustable form factor in accordance with various embodiments;

FIG. 2 illustrates some examples of different configurations of the flashlight of FIG. 1 in use based on varying the customizable tail assembly in accordance with various embodiments;

FIG. 3 illustrates structure that may be utilized to facilitate interchangeability or customization of the tail assembly of the flashlight of FIG. 1 in accordance with various embodiments;

FIG. 4 illustrates some examples of further features that may be implemented in segments of the customizable assembly of the flashlight of FIG. 1 in accordance with various embodiments; and

FIG. 5 illustrates some examples of different configurations of the flashlight of FIG. 1 in use based on varying the clip engagement location in accordance with various embodiments.

### DETAILED DESCRIPTION OF THE DISCLOSURE

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Reference will now be made to the drawings. It can be understood that the drawings may include ornamental and aesthetic design features as aspects of the present disclosure. While some views of the ornamental and aesthetic are shown in the drawings, further orthogonal, perspective, and cross-sectional views can be logically extrapolated and supported by these drawings. Such ornamental and aesthetic design can be appreciated as separate from, integrated with, or existing parallel to the functionality of the overall disclosure; however, the ornamental appearances shown in the drawings is not a design solely or primarily driven or dominated by the function of the disclosure. Indeed, particular contours, boundaries, or other aspects of the drawings shown herein may have no relevance or contribution to the ornamental and aesthetic design of the disclosure.

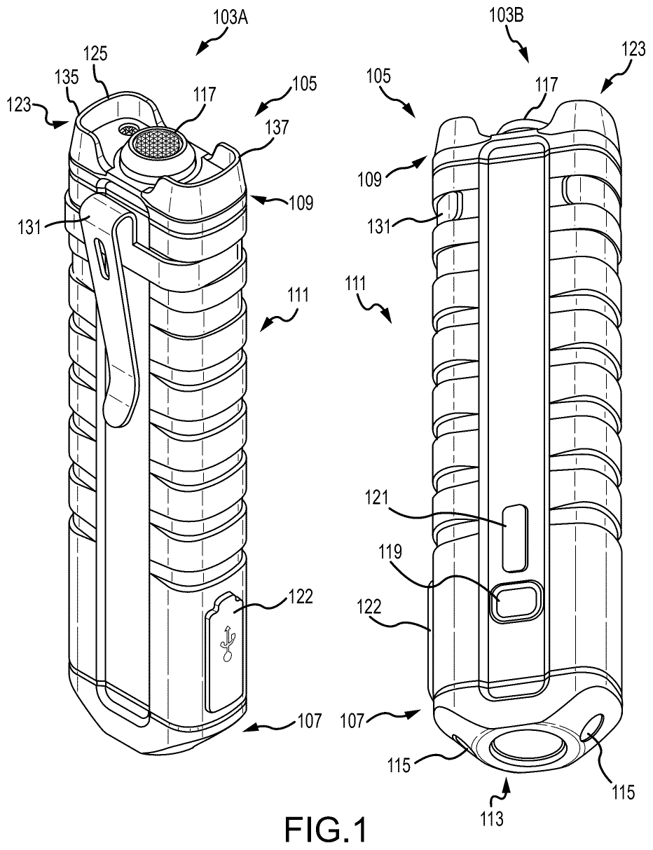

Referring now to the drawings, in which similar identifiers refer to similar elements, FIG. 1 depicts front and rear views of a flashlight 101. The flashlight 101 is shown in a perspective front view 103A at left in FIG. 1 and a perspective rear view 103B in FIG. 1. The flashlight 101 may include a body 105. The body 105 may include different portions or areas. For example, the body 105 may include a head portion 107, a tail portion 109, and a middle portion 111. The middle portion 111 may extend between the head portion 107 and the tail portion 109, for example.

A light source 113 may be included or located in the head portion 107. The light source 113 can include any suitable light-producing structure and/or light-guiding structure. Examples of a light-producing structure can include a LED (light-emitting diode), light bulb, or other light-producing element. Examples of light-guiding structure can include lenses, bezzles, mirrored or other reflecting surfaces (e.g., formed into cones or other shapes), and/or other elements that may reflect, focus, and/or otherwise direct or guide light produced by the light-producing element of the light source 113. The light source 113 may be powered or supplied by a power source that may be contained within the flashlight 101. For example, the light source may be powered by batteries (e.g., rechargeable or one-time use), capacitors, or other power sources in use.

In some arrangements, the flashlight 101 may include one or more body-closing fasteners 115. The light source 113 and/or other components that are housed at least partially within the body 105 of the flashlight 101 may be accessible by removing body-closing fasteners 115 in use. For example, the body-closing fasteners 115 upon removal may permit detachment of at least a portion of the body 105 to gain access to change a bulb or other light-producing component of the light source 113, change batteries or other elements of a power supply, or perform other actions relative to internal components of the flashlight 101 in use. The body-closing fasteners 115 may be suitable for closing the body 105 of a flashlight 101, such as to enclose elements within the body 105 in use or otherwise closing access into the body 105. The body-closing fasteners 115 may correspond to screws or bolts, or any other suitable form of fastener can be utilized.

A tail switch 117 can be included in the flashlight 101. The tail switch 117 may be located in or on the tail portion 109 of the flashlight. The tail switch 117 may be operable to change a setting of the flashlight 101. For example, the tail switch 117 may be operable to turn on and/or turn off the light source 113 in use. The tail switch 117 further may be operable to adjust other operating parameters of the light source 113. Some examples may include adjusting a light intensity provided by the light source and/or a frequency with which light is provided, such as whether in a flashing mode or an enduring mode of providing light. Generally, the tail switch 117 may control the light source 113. The tail switch 117 is depicted as a push-button, although a toggle switch or any other suitable form of manipulatable switch can be utilized.

In some embodiments, a display area 121 can be included. The display arca 121 may include a screen or other indicator that may provide information about operation and/or an operating mode of the flashlight 101. As one example, the display area 121 may display an amount of energy available within the flashlight 101, such as showing a number of bars representing the amount of battery power remaining for consumption, a percentage, or another suitable indicium.

In some embodiments, the flashlight 101 may include a secondary switch 119. The secondary switch 119 may be utilized to control light intensity levels or other operating parameters of the light source 113. In some aspects, the secondary switch 119 may activate or otherwise control the display area 121, for example.

The flashlight 101 may include a port cover 122. The port cover 122 may cover a port, such as to prevent intrusion of dust or other debris when the underlying port is not in use. The port cover 122 may be removable, retractable, and/or otherwise releasably securable to permit access into the underlying port, such as for permitting a cable or connector to be coupled to the flashlight 101 to provide power and/or information relative to the flashlight 101. For example, the port cover 122 may be used to cover a port suitable for charging a rechargeable battery of the flashlight 101. The port cover 122 may cover a USB port or other suitable infrastructure in use.

The flashlight 101 can be equipped with suitable features for providing an alterable form factor of the flashlight 101. For example, features may permit the flashlight to be changed among different form factor options. The flashlight 101 may include elements that can be removable and/or attachable in order to change a configuration and/or form factor of the flashlight 101 in use. As a first example, the body 105 may include or be coupled with a customizable tail assembly 123.

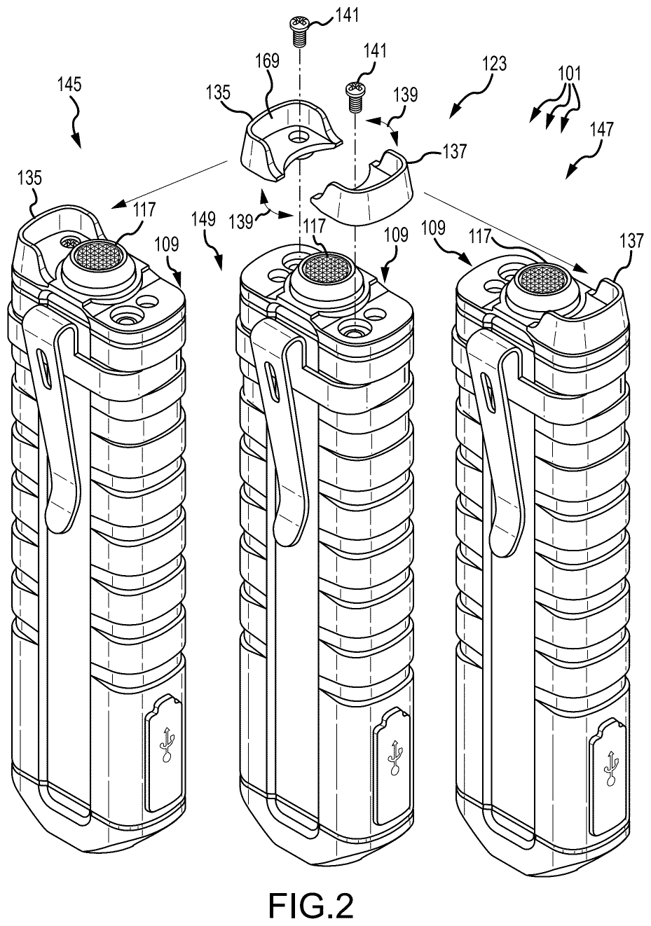

The customizable tail assembly 123 can include a plurality of segments 125. The segments 125 may be individually releasable from and/or releasably attachable relative to the tail portion 109, e.g., to permit customization of the flashlight 101. The segments 125 may be releasable and/or attachable, for example, in the manner described below with respect to FIG. 2. The segments 125 may be releasably attached independently from the tail switch 117. For example, the tail switch 117 may remain attached or in place, and individual segments 125 may be attached or removed adjacent the tail switch 117, e.g., without necessarily causing the tail switch 117 to be removed when an individual segment 125 is removed.

The segments 125 may each be sized to provide a suitable offset to prevent accidental triggering of the tail switch 117. In use, the segments 125 may extend sufficiently to reduce a chance of a user's finger or surface of some other object inadvertently coming into contact with the tail switch 117 to trigger the tail switch 117 in use. For example, the segments 125 may be shaped and/or sized to be arranged so that objects moving along particular paths toward the tail switch 117 will encounter the segments 125 before and/or instead of encountering the tail switch 117. As an illustrative example, the segments 125 may be taller than the tail switch 117 and/or extend further than the tail switch 117 relative to a reference surface of the tail portion 109 of the flashlight 101. Generally, the segments 125 may function as guard segments or as one or more guards to block access toward another portion of the flashlight 101.

Any suitable material can be utilized (including but not limited to aluminum, steel, titanium, carbide, rubber, thermoplastic polyurethane (TPU), rubber, and/or other forms of polymers, metals, and/or other materials). Materials may be incorporated individually and/or in combination, such as to support function, aesthetic, and/or other considerations relative to the segments 125 and/or other elements of the flashlight 101.

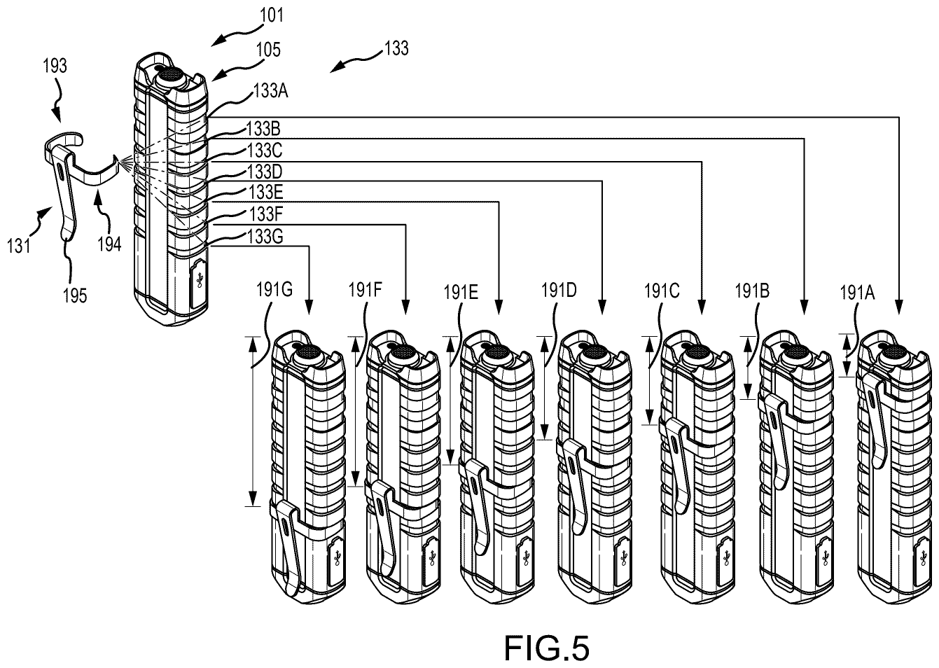

The flashlight 101 is also shown having an adjustable clip 131. The adjustable clip 131 may be removable from the body 105 of the flashlight 101 in use. The adjustable clip 131 may be sized for engaging recesses or grooves 133 formed along the body 105 of the flashlight 101. Further discussion of the adjustable clip 131 and the grooves 133 is provided below with respect to FIG. 5, for example. The flashlight 101 may include the customizable tail assembly 123 and/or the adjustable clip 131 as options for facilitating customization of the flashlight in use.

FIG. 2 illustrates some examples of different configurations of the flashlight 101 in use based on varying the customizable tail assembly 123. The customizable tail assembly 123 can include a first tail segment 135 and a second tail segment 137. The first tail segment 135 and the second tail segment 137 may be examples of and/or more particularized instances of the segments 125 discussed in FIG. 1. The first tail segment 135 is shown arranged for a left side of the flashlight 101 in use (and thus may alternatively be referred to as the left tail segment 135 herein). The second tail segment 137 is shown as arranged for a right side of the flashlight 101 in use (and thus may alternatively be referred to as the right tail segment 137 herein).

The first tail segment 135 and the second tail segment 137 may be removable and/or attachable relative to the tail portion 109 of the flashlight 101 in use. In some arrangements, the first tail segment 135 and the second tail segment 137 may be reversible, such as depicted by arrows 139. For example, the first tail segment 135 or the second tail segment 137 may be rotatable by 180 degrees and fit into a different area of the tail portion 109 of the flashlight 101 in use.

The customizable tail assembly 123 may include suitable anchoring fasteners 141. The anchoring fasteners 141 may correspond to screws or bolts or other forms of fasteners that may be suitable to secure or anchor the first tail segment 135 and/or the second tail segment 137 relative to the tail portion 109 of the flashlight 101. Although one anchoring fastener 141 is shown for each of the first tail segment 135 and the second tail segment 137, any number of anchoring fasteners 141 apiece may be used.

The view in FIG. 2 shows three different configurations for the flashlight 101. At left in FIG. 2, a left tail configuration 145 is shown. At right in FIG. 2, a right tail configuration 147 is shown. In between, in the center of FIG. 2, a tail-segment-free configuration 149 is shown.

The left tail configuration 145 may correspond to a configuration in which the customizable tail assembly 123 has had the right tail segment 137 removed and the left tail segment 135 retained in an installed position. In the left tail configuration 145, the tail portion 109 of the flashlight 101 may be arranged to guard against inadvertent operation of the tail switch 117 by contact from a leftward direction (e.g., by virtue of the presence of the left tail segment 135) and may facilitate ready or easier access to the tail switch 117 from a right side (e.g., by virtue of the absence of the right tail segment 137) or from a position of being directly above.

In comparison, the right tail configuration 147 may correspond to an arrangement in which the left tail segment 135 has been removed and the right tail segment 137 has been retained in an installed position. In the right tail configuration 147, the tail portion 109 of the flashlight 101 may be arranged to guard against inadvertent operation of the tail switch 117 by contact from a rightward direction (e.g., by virtue of the presence of the right tail segment 137) and may facilitate ready or easier access to the tail switch 117 from a left side (e.g., by virtue of the absence of the left tail segment 135) or from a position of being directly above.

In an illustrative example, switching between the left tail configuration 145 and the right tail configuration 147 may allow a user to customize whether it is easier to turn on or off the flashlight 101 by reaching toward the tail switch 117 from a left side or a right side of the flashlight 101. Customizing may be useful, for example, to accommodate which hand (e.g., left hand or right hand) a user expects to be using for the flashlight 101. For example, if a user will be reaching toward a shirt pocket or vest pocket along the front of the user's torso to retrieve the flashlight 101, the user's thumb may approach from the left if using the left hand or may approach from the right if using the right hand. Customizing the grip on the flashlight thus may allow the flashlight 101 to be reconfigured among arrangements respectively configured to facilitate a “left hand draw” or a “right hand draw” in use. For example, in some embodiments, the flashlight 101 may be converted into a left-hand draw configuration by removing a leftward tail segment 125 or converted into a right-hand draw configuration by removing a rightward tail segment 125.

The tail-segment-free configuration 149 may correspond to an arrangement in which the left tail segment 135 has been removed and the right tail segment 137 has been removed. The tail-segment-free configuration 149 may facilitate a user being able to readily access the tail switch 117 from either the left or the right or from a position of being directly above. In contrast, a configuration (such as in FIG. 1) that includes both the first tail segment 135 and the second tail segment 137 may block access to the tail switch 117 from left or right sides while still enabling reaching and/or operating the tail switch 117 from directly above in operation.

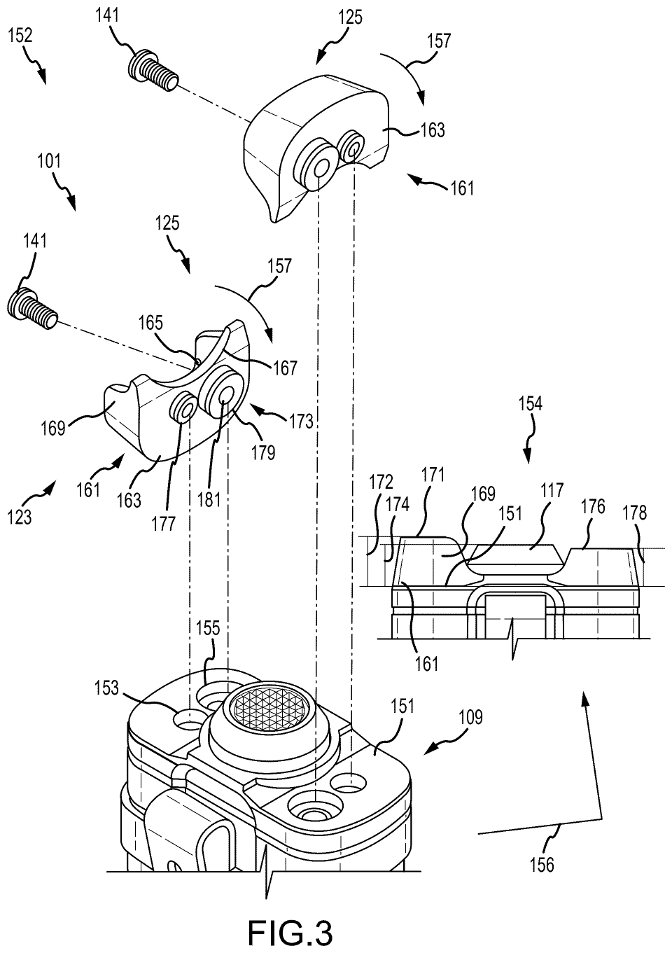

FIG. 3 illustrates additional structure that may be utilized to facilitate interchangeability or customization of the tail assembly 123. The segments 125 in FIG. 3 are shown rotated in order to more easily see some features along different areas or portions of the parts. For example, the segments shown in FIG. 3 may be rotated by approximately 90 degrees (such as illustrated by arrows 157) to arrive at a position similar to that shown exploded in FIG. 2 and/or to align for installation.

The tail assembly 123 may be installable relative to the tail portion 109 of the flashlight 101, which may include features that may facilitate alignment and/or engagement with the tail assembly 123. The tail portion 109 of the flashlight 101 may include an end-facing surface 151. The end-facing surface 151 may include suitable features for engaging components of the customizable tail assembly 123. The end-facing surface 151 is shown with a first alignment recess 153 and a second alignment recess 155. Respectively, the first alignment recess 153 and the second alignment recess 155 may be sized to engage respective shapes of features that may be present on the segments 125. The segments 125 are shown in an exploded view 152 at left in FIG. 3 and may be assembled to arrive at the front view 154 at right in FIG. 3, such as depicted by arrow 156.

The segment 125 can include a base 161. The base 161 can have a top 165 and a bottom 167. The top 165 can be opposite the bottom 167. The top 165 can face away from a body 105 of the flashlight 101 in use, for example. The base 161 may include a body-facing surface 163, which may be arranged along the bottom 167 of the base 161. For example, the body-facing surface 163 may face toward the body 105 of the flashlight 101 in use. The body-facing surface 163 may be shaped to align with, contact, and/or nest against the end-facing surface 151 of the tail portion 109 of the flashlight 101.

The base 161 may include or be coupled with an extension 169. The extension 169 may extend from the top 165 of the base 161. In some embodiments, the extension 169 may be tapered, may have a flat tip, and/or may otherwise be suitably shaped and/or formed to function as a prying tool (e.g., formed of suitable material and/or geometry to exhibit sufficient robustness to wedge in between elements that are to be pried apart in use). Additionally or alternatively, the extension 169 may define or form a wall arranged to block a lateral path toward the tail switch 117, e.g., which may facilitate avoiding inadvertent triggering of the tail switch 117 in use. The extension 169 be arranged along a boundary and/or otherwise extend along at least a part of the top 165 of the base 161. For example, as may be most easily seen in FIG. 2 beneath the anchoring fastener 141 at the top of the view, the extension 169 may be shaped as a wall along an upper area (e.g., which may be penetrated by a through-hole, such as for receiving the anchoring fastener 141).

As may be most easily seen by way of example in the front view 154 in FIG. 3, the extension 169 may define an offset surface 171. The offset surface 171 may represent a furthermost extent of the extension 169 and/or a part of the extension 169 that is farthest from the base 161 compared to any other portion of the extension 169. The segment 125 when installed may extend further than the tail switch 117 from the end-facing surface 151. For example, while both the tail switch 117 and the segment 125 may protrude away from the end-facing surface 151 of the tail portion 109 of the flashlight 101, a terminus or furthest extent of the segment 125 (e.g., the offset surface 171) may be arranged relative to the end-facing surface 151 at a first distance 172, which may be larger than a second distance 174 at which a terminus or furthest extent of the tail switch 117 is arranged relative to the end-facing surface 151. Arranging the segment 125 to extend further than the tail switch 117 may allow the segment 125 to block movement of objects toward the tail switch 117 along various trajectories and so reduce chances of accidental operation of the tail switch 117. In some examples, the tail assembly 123 may be suitably sized and shaped such that the tail assembly 123 can be placed against a support surface to support the flashlight 101 with the tail switch 117 out of contact with the support surface. However, as shown at least by way of example in a rightward portion of the front view 154 in FIG. 3, in some examples, the segment 125 when installed may extend less than the tail switch 117 from the end-facing surface 151. For example, while both the tail switch 117 and the segment 125 may protrude away from the end-facing surface 151 of the tail portion 109 of the flashlight 101, a terminus or furthest extent of the segment 125 (e.g., a reduced offset surface 176) may be arranged relative to the end-facing surface 151 at a relative distance 178, which may be smaller than the second distance 174 at which a terminus or furthest extent of the tail switch 117 is arranged relative to the end-facing surface 151. Arranging the segment 125 to extend less than the tail switch 117 may allow the segment 125 to block some movement while allowing some other movement of objects toward the tail switch 117 along various trajectories. In some examples, arranging the segment 125 to extend less than the tail switch 117 may position the reduced offset surface 176 at a suitable position to act as a suitable guide to indicate a suitable depth to push the tail switch 117 to activate a “momentary on” or other mode that may be activated by pressing the tail switch 117 less than a full actuation distance. Although different sizes of segments 125 are shown at right and left in the front view 154 in FIG. 3, segments 125 along differing portions of the flashlight 101 may be similarly or differently sized from one another.

The base 161 or other portion of the segment 125 may include, bear, or be coupled with an attachment interface 173. The attachment interface 173 may include suitable structure for engaging the tail portion 109 of the flashlight 101. The attachment interface 173 may be arranged on the bottom 167 of the base 161 of the segment 125. The attachment interface 173 may be configured to engage the tail portion 109 of the flashlight 101 so as to be individually releasable or individually releasably attached relative to the flashlight 101.

In the arrangement depicted in FIG. 3, the attachment interface 173 includes a lug 177 and a peg 179. The lug 177 may be sized to engage the first alignment recess 153 along the end-facing surface 151 of the tail portion 109 of the flashlight 101. The peg 179 may be suitably sized to engage the second alignment recess 155 along the end-facing surface 151. The peg 179 may include a through-hole 181, for example, which may be sized to facilitate passage of the anchoring fastener 141 therethrough. In use, the anchoring fastener 141 may extend through the through-hole 181 and into the second alignment recess 155. For example, the anchoring fastener 141 and the second alignment recess 155 may include matching threaded surfaces and/or may be otherwise suitably shaped and/or sized for engagement to secure the anchoring fastener 141.

The lug 177 and the peg 179 may be differently sized from one another and provide suitable alignment as a result. For example, the lug 177 and peg 179 may be sized according to the sizes of the first alignment recess 153 and the second alignment recess 155 to match or fit in to provide an interference or other suitable fit for providing engagement for remaining in place in use. Other instances of the first alignment recess 153 and the second alignment recess 155 may be provided in flipped orientation on an opposite side of the tail switch 117, which may allow the segments 125 to be reversible such as described with respect to FIG. 2, for example.

More generally, the lug 177 and the peg 179 may each have and/or exhibit a different maximum cross-sectional dimension, which may facilitate indexing or alignment in use. For example, although the lug 177 and the first alignment recess 153 are depicted in FIG. 3 with smaller diameters than the peg 179 and the second alignment recess 155 to facilitate engagement in a particular orientation in which like-sized features align, options need not be limited to differences in diameter but may additionally or alternatively leverage differences in height, width, depth, or other dimensions. Moreover, although FIG. 3 depicts an arrangement in which the end-facing surface 151 includes openings to receive protrusions from the segment 125, placement may be flipped or varied, e.g., such that any combination of protrusions and/or openings can be distributed across the end-facing surface 151 and/or the segments 125 to achieve suitable engagement.

The customizable tail assembly 123 is not limited to the particular examples shown in FIGS. 1 through 3. Other variations may be utilized, including but not limited to others described herein.

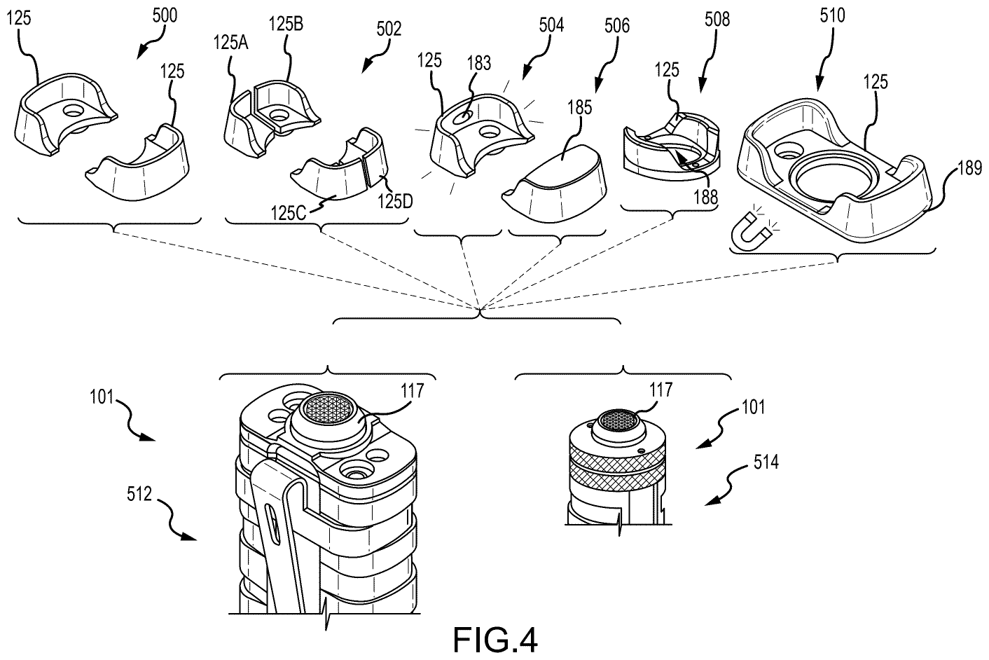

FIG. 4 illustrates some examples of other features that may be implemented in segments 125 of the customizable tail assembly 123. At left, particularly at 500, segments 125 are shown with features in accordance with description and depiction from earlier figures for ease of reference.

Although two segments 125 are shown at 500, the customizable tail assembly 123 may be utilized with other numbers of segments 125, such as one, two, three, four, or more. As an example at 502, four pieces are shown in lieu of two pieces. The pieces shown at 502 are individually denoted as 125A, 125B, 125C, and 125D and may correspond to parts similar to those shown at 500, though differing by including four segments that represent a further dividing of parts into four parts instead of two. The inclusion of four parts may allow for further customizing in terms of number of directions that may be available to use for approach and/or configuring in use.

In some embodiments, a given segment 125 may be capable of performing additional or alternative functions. In some embodiments, a given segment 125 may be formed as secondary tool, such as in one or more of the following examples.

At 504, a segment 125 is shown with a tethering hole 183. The tethering hole 183 may be sized to receive a lanyard or otherwise facilitate coupling with a tether or other structure. At 504, the segment 125 is also shown as including suitable material to exhibit a glowing visual appearance. Although shown with the tethering hole 183, the glowing visual appearance may be in addition to, in lieu of, or independent of the tethering hole 183. The glowing visual appearance may correspond to a suitable construction to emit light from the segment 125. In some examples, the segment 125 may include an independent light source and/or may be suitably coupled to direct light from a light source. In some examples, material used in the segment 125 may include phosphors or other suitable formulations to be capable of absorbing energy (e.g., via ultraviolet radiation) and emitting light (e.g., as a glow-in-the-dark output). Any other material suitable for this function may be included and may be utilized alongside and/or in lieu of other material options for other elements of the flashlight 101.

At 506, the segment 125 is shown with a striking surface 185. The striking surface 185 which may correspond to an upper area of the segment 125 being occupied with material, e.g., rather than an area that is recessed. The striking surface 185 may be suitably sized, shaped, and/or otherwise formed for breaking a window (e.g., as may be a tool of interest on a flashlight 101 for law enforcement, military, first responders, or other applications, such as for emergency egress from within a disabled vehicle by breaking through a windshield etc. to form an exit path for an occupant). Metal, plastic, or any other material suitable for this function may be included and may be utilized alongside and/or in lieu of other material options for other elements of the flashlight 101.

FIG. 4 also illustrates that the customizable tail assembly 123 may be utilized with any form factor of flashlight 101. For example, although a rectangular form factor is shown at 512, other form factors may be utilized. One example of a round form factor is shown at 514, although any other oval-, circle-like, or other cross-sectional shape may be utilized additionally or alternatively. The segments 125 may be accordingly modified to accommodate such difference in form factor of the body 105 of the flashlight 101 in use.

At 508, the segment 125 is shown with an outer periphery suitably shaped to fit a circular flashlight 101. The segment 125 is further shown with a hole 188 that may be suitably sized for fitting around the tail switch 117 in use. For example, the hole 188 may be bounded by a rim that may fit around the tail switch 117. Overall, the segment 125 may be sized and/or shaped to facilitate removal of the segment 125 independent of the tail switch 117 (e.g., such that the tail switch 117 may remain in place to facilitate operation of the flashlight 101 regardless of whether the segment 125 is present or absent). Allowing the segment 125 to be removable independent of the tail switch 117 may allow customization and/or differentiate from arrangements in which access to batteries is provided by a removal of single combined tail cap that incorporates a button and adjacent guard structure such that the button and adjacent guard structures are always kept together on the combined tail cap instead of being independently detachable. Moreover, although the segment 125 is depicted as a single piece, the segment 125 may be divided along the depicted dashed lines into two pieces or otherwise divided along any other suitable locations into any suitable number of two, three, four, or more pieces.

At 510, the segment 125 is shown with a magnetic attachment interface 189. The magnetic attachment surface 189 illustrates that any form of attachment interface may be utilized in use, in addition or as an alternative to the lug 177 and/or peg 179 described previously. The segment 125 depicted at 510 may also represent an example of a single-piece segment 125 that may be utilized with a flashlight 101 having a rectangular form factor (such as at 512), although any arrangement with one piece, two pieces, or more may be utilized for any segment 125.

FIG. 5 illustrates different configurations of the clip 131 relative to the body 105 of the flashlight 101. The body 105 may include a series of grooves 133 which are denoted as 133A, 133B, 133C, 133D, 133E, 133F, and 133G in FIG. 5. Although seven grooves 133 are shown in FIG. 5, any number of one or two or more grooves 133 may be utilized. Moreover, the grooves 133 may be similar to one another or different from one another. For example, while discussion below primarily discusses arrangements in which all the grooves 133 are similarly sized to each be capable of receiving the clip 131, in some examples, a subset of the grooves 133 may be particularly sized to receive the clip 131. In one illustrative example, the top two grooves 133A and 133B may be suitably deep and/or tall for interchangeably receiving the clip 131, while the remaining grooves 133C, 133D, 133E, 133F, and 133G may be relatively shallower and/or otherwise arranged to provide an ergonomic grip. However, it will be understood that any combination of similar or different sized and/or shaped grooves 133 may be included in any suitable number.

In use, the clip 131 may engage a different one of the grooves 133 to adjust a height at which the clip is arranged. For example, this may allow the flashlight 101 to rest in a pocket, pouch, or other receptacle with a different overall height extending (e.g., such as depicted by the respective heights of differing sizes at 191A through 191G).

The clip 131 may include a C-shape or other shape suitable for engaging the grooves 133. The clip 131 may, for example, include a first arm 193 and a second arm 194. The first arm 193 and the second arm 194 can each extend away from a central bar 195. The first arm 193 and the second arm 194 may curve, bend, or otherwise be shaped to at least partially enclose a central area and define an opening into the central area (e.g., in order to form the C-shape). The central bar 195 may extend in a first direction (e.g., substantially vertically) while the arms 193 and 194 may extend in a second direction (e.g., substantially horizontally). The arms 193 and 194 may each include a portion that extends laterally from the central bar 195 and that transitions into a further portion extending rearwardly. The first arm 193 and the second arm 194 may terminate with ends that are oriented at least partially toward one another.

The clip 131 may be formed of material that is suitably flexible to allow the clip 131 to bow outwardly along the arms 193 and 194 to facilitate removal of the clip 131 (e.g., from a respective groove 133) when reconfiguring of the clip 131 among different positions. Material used in the clip 131 may further exhibit suitable resiliency to exhibit some spring characteristics, such as to permit clamping of the arms 193 and 194 of the clip 131 around the flashlight 101 (e.g., within a groove 133) and/or to permit the central bar 195 to clamp the flashlight 101 to a wall of a pocket, pouch, or other receptacle (such as by being hooked over an edge of the wall at one end of the central bar 195 and having an opposite end of the central bar 195 suitably angled or arranged to sandwich the wall between the clip 131 and the body 105 of the flashlight 101).

In addition or as an alternative to changing a height of a location of the clip 131, the clip 131 may be attachable in a groove 133 to alter other relative locations with respect to the flashlight 101. For example, at least some of the grooves 133 may be arranged to receive the clip 131 from differing sides (e.g., front, back, etc.) of the flashlight 101. This may adjust along which side the clip 131 is positioned (e.g., whether the central bar 195 is along the front, back, side, or other location of the flashlight 101). For example, a user may detach the clip 131 from a particular groove 133, rotate the flashlight 101 by a half turn around a longitudinal axis, and engage the clip 131 in the same (or another) groove 133 so that the clip 131 will be arranged to have the central bar 195 facing the rear instead of the front of the flashlight 101 or vice versa. The geometry of the clip 131 may be suitable for retaining the flashlight 101 to orient features at a particular orientation, e.g., which may be useful to avoid inadvertent spinning or rotating of the flashlight 101 within the clip 131.

Based on the disclosure and teachings provided herein, a person of ordinary skill in the art will appreciate other ways and/or methods to implement the various embodiments. The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

What is claimed is:

1. A flashlight comprising:
a body defining a head portion, a tail portion, and a middle portion extending between the head portion and the tail portion;
a light source located in the head portion;
a tail switch located in the tail portion and operable to change a setting of or otherwise control the light source; and
a customizable tail assembly comprising one or more segments individually releasably attached to the tail portion and individually releasable independent of the tail switch.

2. The flashlight of claim 1, wherein the tail switch and the segments each protrude away from an end-facing surface of the tail portion, and wherein at least one of the segments extends further than the tail switch from the end-facing surface.

3. The flashlight of claim 1, wherein the segments are sized to provide an offset to prevent accidental triggering of the tail switch.

4. The flashlight of claim 1, wherein each segment includes a base having a bottom bearing an attachment interface configured for engaging the tail portion.

5. The flashlight of claim 4, wherein each segment includes an extension extending away from a top of the base.

6. The flashlight of claim 5, wherein the extension is shaped as a wall along an upper area that is penetrated by a through-hole.

7. The flashlight of claim 4, wherein the attachment interface comprises a lug and a peg each extending from the bottom of the base and each having a different maximum cross-sectional dimension.

8. The flashlight of claim 1, wherein at least one of the segments is formed as a secondary tool that includes at least one of a tether attachment tool, a window break tool, or a prying tool.

9. The flashlight of claim 1, further comprising a clip, wherein the body of the flashlight further comprises a plurality of grooves arranged to receive the clip at different positions along the body so as to adjust an amount of the flashlight that extends above the clip.

10. The flashlight of claim 9, wherein the grooves are arranged to receive the clip from differing sides of the flashlight so as to adjust along which side the clip is positioned.

11. A tail assembly for a flashlight tail portion, the tail assembly comprising:
a base having a top and a bottom; and
an attachment interface included in or coupled along the bottom of the base and operable to releasably attach the bottom of the base along an end-facing surface of a flashlight independently from a tail switch extending from the end-facing surface.

12. The tail assembly of claim 11, further comprising an extension extending from the top of the base and forming a wall arranged to block a lateral path toward the tail switch in an installed position.

13. The tail assembly of claim 12, wherein the extension comprises a terminus defining an offset surface configured to be positioned in the installed position a larger distance from the end-facing surface than a distance the tail switch extends from the end-facing surface.

14. The tail assembly of claim 11, wherein the attachment interface comprises a lug and a peg each extending from the bottom of the base and each having a different maximum cross-sectional dimension.

15. The tail assembly of claim 14, wherein the peg is penetrated by a threaded through-hole.

16. A method of reconfiguring a flashlight form factor, the method comprising:
accessing a flashlight having a tail portion with a tail switch and at least one tail segment individually releasably attached to the tail portion independently of the tail switch; and detaching at least one tail segment so as to convert the flashlight into a different configuration.

17. The method of claim 16, wherein the flashlight is converted into a left-hand draw configuration by removing a leftward tail segment from the at least one tail segment.

18. The method of claim 16, wherein the flashlight is converted into a right-hand draw configuration by removing a rightward tail segment from the at least one tail segment.

19. The method of claim 16, wherein the flashlight is converted into a tail-segment-free configuration by removing a leftward tail segment and a rightward tail segment from the at least one tail segment.
